(19) United States
(12) Patent Application Publication
(10) Pub. No.: US 2007/0168431 A1
(43) Pub. Date: Jul. 19, 2007

(54) Multi-file transfer via instant messaging

(75) Inventors: Ruthie D. Lyle, Durham, NC (US); Fonda Daniels, Cary, NC (US); James P. Galvin JR., Oak Ridge, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/315,057

(22) Filed: Dec. 22, 2005

(51) Int. Cl. G06F 15/16

(52) U.S. Cl. 709/206

(57) ABSTRACT

The present invention provides multi-file transfer via instant messaging. A method in accordance with an embodiment of the present invention includes: selecting a plurality of files to be transferred; generating a collection descriptor describing the files; sending an instant message with a collection reference that includes the collection descriptor to a recipient; and upon receipt of the instant message, the recipient selectively retrieving at least one of the files.

### BACKGROUND OF THE INVENTION

1. Field of the Invention

The present invention generally relates to instant messaging, and more specifically relates to multi-file transfer via instant messaging.

2. Related Art

Many instant messaging (IM) systems allow users to transfer individual files to their peers. However, a user may wish to send a collection of files that are related in some way. In some cases, these files may have a very loose relationship, such as the location of the files on a file system (e.g., all files located in a particular directory), or a more complex relationship, such as a group of files that make up a marketing campaign, a product installation, or a software project, etc. Unfortunately, there is no easy way to transfer such a collection of files using available IM systems. Although a user could combine a collection of files together into a single file (e.g., a zip file), sending such a file in a single IM transfer introduces the problem that not all users will want to receive all of the information contained in the file at once. Also, there is no notion of lazy transfer, soft dependencies/relationships, or of inline-transformation of individual files. These capabilities are especially needed for users of mobile devices, which typically have limited capability to receive, store, and display large amounts of information. Further, bandwidth constraints may limit the amount of data that can be transferred at one time.

In view of the foregoing, there is a need in the art for an improved way to transfer multiple files via instant messaging.

### SUMMARY OF THE INVENTION

The present invention allows a user to transfer multiple files to one or more remote peers via instant messaging.

A first aspect of the present invention is directed to a method for multi-file transfer via instant messaging, comprising: selecting a plurality of files to be transferred; generating a collection descriptor describing the files; sending an instant message with a collection reference that includes the collection descriptor to a recipient; and upon receipt of the instant message, the recipient selectively retrieving at least one of the files. The collection descriptor can comprise information including, for example: the name and location of each file to be transferred, the relationships between the files (if any), the properties of each file to be transferred (e.g., type, size, author, brief description, modification date, transfer completion criteria (e.g., time limit), etc.), and/or the available transformations (e.g., in-line transformations) that can be performed as part of the transfer. The collection reference provides information regarding the files to be transferred, including, for example: the file transfer protocol to be used, the physical location of the files to be transferred, and the name of the collection descriptor.

A second aspect of the present invention is directed to a system for multi-file transfer via instant messaging, comprising: a system for selecting a plurality of files to be transferred; a system for generating a collection descriptor describing the files; a system for sending an instant message with a collection reference that includes the collection descriptor to a recipient; and a system for allowing the recipient, upon receipt of the instant message, to selectively retrieve at least one of the files.

A third aspect of the present invention is directed to a program product stored on a computer readable medium for multi-file transfer via instant messaging, the computer readable medium comprising program code for performing the steps of: selecting a plurality of files to be transferred; generating a collection descriptor describing the files; sending an instant message with a collection reference that includes the collection descriptor to a recipient; and upon receipt of the instant message by the recipient, selectively retrieving at least one of the files.

A fourth aspect of the present invention is directed to a method for deploying an application for multi-file transfer via instant messaging, comprising: providing a computer infrastructure being operable to: select a plurality of files to be transferred; generate a collection descriptor describing the files; send an instant message with a collection reference that includes the collection descriptor to a recipient; and selectively retrieve, upon receipt of the instant message by the recipient, at least one of the files.

A fifth aspect of the present invention is directed to computer software embodied in a propagated signal for multi-file transfer via instant messaging, the computer software comprising instructions to cause a computer system to perform the functions of: selecting a plurality of files to be transferred; generating a collection descriptor describing the files; sending an instant message with a collection reference that includes the collection descriptor to a recipient; and upon receipt of the instant message, the recipient selectively retrieving at least one of the files.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative flow diagram of a process for specifying the files to be transferred via instant messaging in accordance with an embodiment of the present invention.

FIG. 2 depicts an illustrative flow diagram of a process for retrieving the files to be transferred in accordance with an embodiment of the present invention.

FIG. 3 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

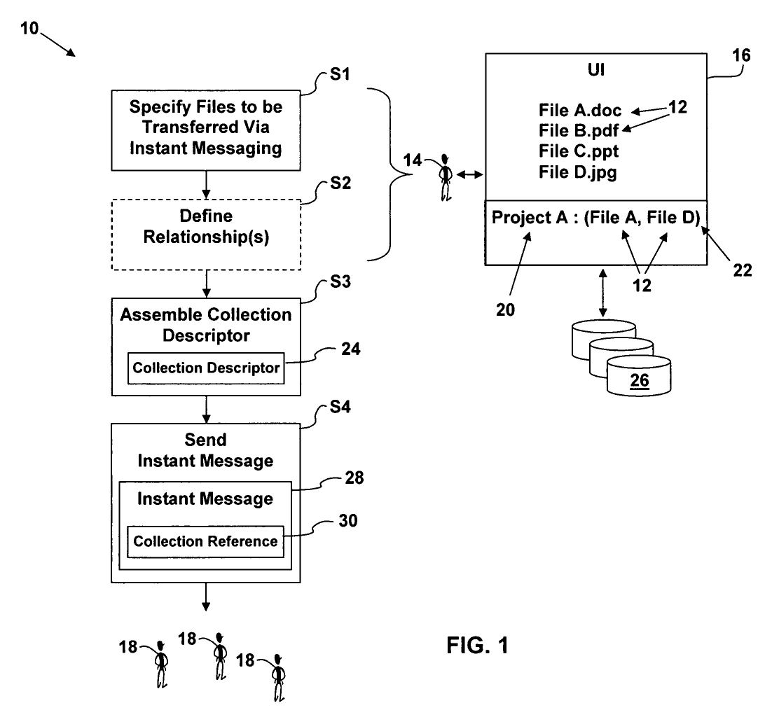

An illustrative flow diagram 10 of a process for specifying a plurality of files 12 to be transferred via instant messaging in accordance with an embodiment of the present invention is illustrated in FIG. 1.

In step SI, a user 14 specifies, via a user interface 16, the files 12 that are to be transferred to one or more recipients 18 via instant messaging. In optional step S2, shown in phantom, the user 14 specifies, again via the user interface 16, one or more relationships 20, each defining a collection 22 of files 12 that are related in some way. The files 12 in a collection 22 can be loosely related, such as the location of the files 12 on a file system (e.g., all files 12 located in a particular directory), or more tightly related, such as a group of files 12 that make up a marketing campaign, a product installation, or a software project, etc. Any desired type of relationship 20 can be specified by the user 14.

Based at least in part on the information provided in step S1 and optional step S2, a “collection descriptor” 24, which describes the files 12 to be transferred, is assembled in step S3. The collection descriptor 24 can comprise information including, for example: the name and location of each file 12 to be transferred, the relationships between the files 12 (if any), the properties of each file 12 to be transferred (e.g., type, size, author, brief description, modification date, transfer completion criteria (e.g., time limit), etc.), and/or the available transformations that can be performed as part of the transfer. The collection descriptor 24 can be provided in XML (extensible Markup Language) or in any other suitable format. The plurality of files 12 to be transferred can be stored in one or more repositories 26 that are accessible to both the user 14 and each recipient 18. Access control can be provided in any known manner (e.g., via username/password) to prevent unauthorized persons from accessing the files 12 in the repositories 26.

In step S4, an instant message 28 is sent to each intended recipient 18 in a conventional manner (e.g., using an instant messaging client). In accordance with the present invention, a “collection reference” 30 is included with the instant message 28. The collection reference 30 can be used by each recipient 18 to retrieve the files 12 that the user 16 who sent the instant message 28 wishes to transfer to the recipient 18. The collection reference 30 provides information regarding the files 12 to be transferred, including, for example: the file transfer protocol to be used, the physical location of the files 12 to be transferred, and the name of the associated collection descriptor 24.

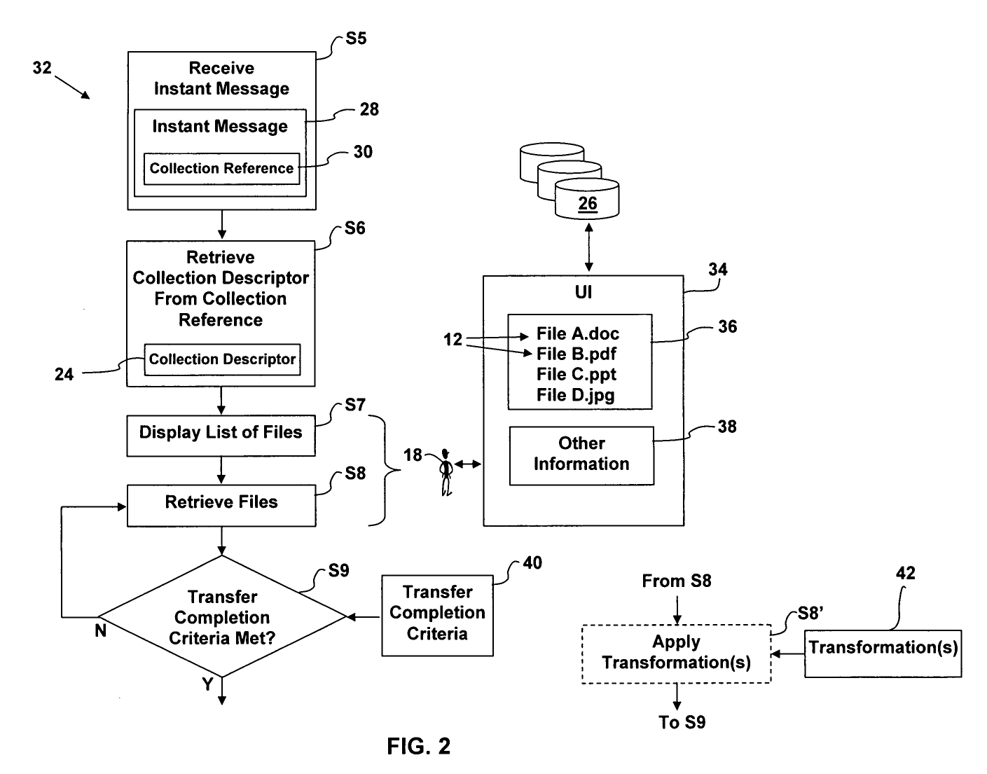

FIG. 2 depicts an illustrative flow diagram 32 of a process for retrieving the files 12 to be transferred in accordance with an embodiment of the present invention.

In step S5, a recipient 18 receives the instant message 28 in a conventional manner (e.g., using an instant messaging client). In step S6, the collection descriptor 24 is retrieved from the collection reference 30, which was included with the instant message 28. Based on the information provided in the retrieved collection descriptor 24, a user interface 34 displays, in step S7, a list 36 of the files 12 that the user 14 who sent the instant message 28 wishes to transfer to the recipient 18. The user interface 34 can also be configured to display other information 38 to the recipient 18, such as various properties of each file 12 to be transferred (e.g., type, size, author, modification date, transfer time limit, brief description, etc.), available transformations, information regarding relationship(s) 20 and collection(s) 22 of files 12, etc.

In step S8, based on automatic settings, user preference, user input, and/or other factors, each recipient 18 may retrieve all or a portion of the files 12 presented in the list 36 from the repository(ies) 26 in which the files 12 are stored. The files 12 may be organized on the computer of the recipient 18 in accordance with any required file organization (e.g., in accordance with the relationship(s) 20 and collection(s) 22 (if any) defined by the user 14), as specified in the collection descriptor 24. The recipient 18 may return at a later time to retrieve any files 12 on the list 36, including those not retrieved the first time. The files 12 will remain available until one or more predetermined transfer completion criteria 40, set by the user 14 are met in step S9. Example completion criteria 40 may include, for example:
(1) All recipients 18 have retrieved all files 12 in the list 36.
(2) A transfer time limit has expired. The recipient 18 can retrieve the files 12 in the list 36 at any time, if no time limit has been set on the transfer of any of the files 12, or within a specified time, if a transfer time limit has been specified. The same time limit may be specified for all of the files 12 in the list 36. Alternatively, different time limits may be specified for different files 12 in the list 36.
(3) Other criteria.

In some cases, the recipient 18 may wish to receive a filtered version of one or more files 12, based on available transformation(s) 42 specified in the collection descriptor 24. For example, a recipient 18 on a mobile device may wish to receive a text-only version of a file 12 that contains large graphics or other multimedia content. That recipient 18 could later retrieve from his/her desktop machine the original version of the file 12. This process is illustrated in FIG. 2 as optional step S8′. Other examples of transformations 42 may include, for example, the conversion of a file 12 in a .doc format (Microsoft Word) to a .pdf format (Adobe Acrobat) or the conversion of a file 12 in a .ppt format (Microsoft PowerPoint) into a .txt format (pure text) with all graphics removed. It will be apparent to one skilled in the art that a wide variety of other transformations 42 could be provided/used in the practice of the present invention.

In addition to, or in lieu of, transformations 42, one or more of the files 12 may be provided in a plurality of different formats. To this extent, the recipient 18 can choose (e.g., via the user interface 34) to retrieve a given file 12 in a desired format. For example, the same file 12 “File A” could be provided in both a .pdf format and a .doc format. The recipient 18 may then selectively retrieve the file 12 “File A” in either or both available formats.

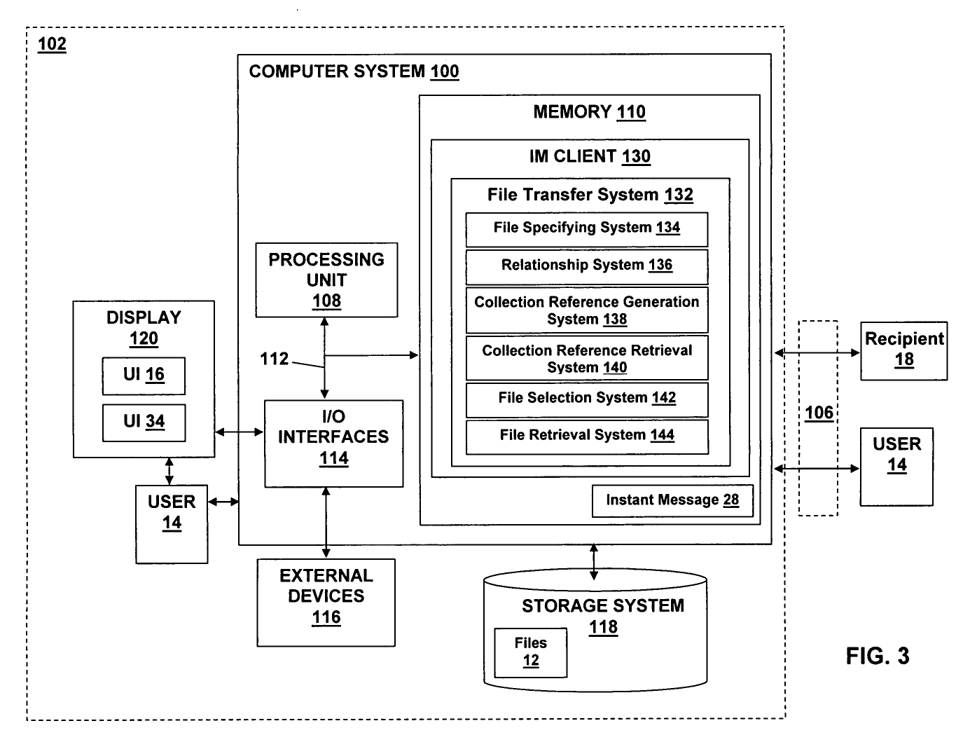

A computer system 100 for multi-file transfer via instant messaging in accordance with an embodiment of the present invention is depicted in FIG. 3. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides multi-file transfer via instant messaging in accordance with the present invention. It should be appreciated that a user 14 can access computer system 100 directly, or can operate a computer system that communicates with computer system 100 over a network 106 (e.g., the Internet, a wide area network (WAN), a local area network (LAN), a virtual private network (VPN), etc).

In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as instant messaging client 130 and file transfer system 132, stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 3 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 14 can contain computerized components similar to those described above with regard to computer system 100.

Shown in memory 110 (e.g., as a computer program product) is an instant messaging client 130 for generating and receiving instant messages 28 and for providing for multi-file transfer via instant messaging in accordance with the present invention, as described above. The instant messaging client 130 includes a file transfer system 132. The file transfer system 132 includes a file specifying system 134 for specifying via a user interface 16 the files 12 (e.g., stored in storage system 118) that are to transferred to one or more recipients 18, a relationship system 136 for specifying relationships (if any) between the files 12, and a collection reference generation system 138 for generating a collection reference 30 (FIGS. 1, 2) to be included with an instant message 28 sent to the one or more recipients 18, as detailed above. The file transfer system 132 also includes a collection descriptor retrieval system 140 for retrieving a collection descriptor 24 (FIGS. 1, 2) from a collection reference 30 included with a received instant message 28, and for displaying via a user interface 34 a list 36 of the files 12 to be transferred to the user 14 as specified in the retrieved collection descriptor 24. A file selection system 142 is used to select one or more of the files 12 from the list 36. A file retrieval system 144 is used to retrieve (and transform if desired) the selected file(s) (e.g., from the storage system 118).

The present invention can be offered as a business method on a subscription or fee basis. For example, one or more components of the present invention can be created, maintained, supported, and/or deployed by a service provider that offers the functions described herein for customers. That is, a service provider can be used to provide a service for multi-file transfer via instant messaging, as described above.

It should also be understood that the present invention can be realized in hardware, software, a propagated signal, or any combination thereof. Any kind of computer/server system(s)— or other apparatus adapted for carrying out the methods described herein— is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which— when loaded in a computer system— is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk - read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for multi-file transfer via instant messaging, comprising:
selecting a plurality of files to be transferred;
generating a collection descriptor describing the files;
sending an instant message with a collection reference that includes the collection descriptor to a recipient; and
upon receipt of the instant message, the recipient selectively retrieving at least one of files.

2. The method of claim 1, wherein the collection descriptor further describes at least one of: a name and location of each file, one or more relationships between the files, one or more properties of each file, and one or more available transformations that can be performed on each file as part of the transfer.

3. The method of claim 1, wherein the collection reference further provides at least one of a file transfer protocol to be used, a physical location of each file, and a name of the collection descriptor.

4. The method of claim 1, further comprising:
specifying at least one relationship defining a collection of the files; and
including information regarding each relationship in the collection descriptor.

5. The method of claim 4, further comprising:
displaying information regarding each relationship to the recipient.

6. The method of claim 5, further comprising:
transferring a collection of the files defined by a relationship to the recipient; and
organizing the transferred collection of files on a computer of the recipient in accordance with the relationship.

7. The method of claim 1, further comprising:
displaying a list of the files to the recipient.

8. The method of claim 7, further comprising:
selecting, by the recipient, at least one of the files from the list; and
transferring each selected file to the recipient.

9. The method of claim 8, further comprising:
selecting, by the recipient after the transferring step, at least one additional file from the list; and
transferring each additional selected file to the recipient.

10. The method of claim 1, further comprising:
setting a transfer completion criterion; and
preventing transfer of the files to the recipient after the transfer completion criterion has been met.

11. The method of claim 1, further comprising:
selecting, by the recipient, a file from the list;
selecting, by the recipient, a transformation to be performed on the selected file;
performing the transformation on the selected file to provide a transformed file; and
transferring the transformed file to the recipient.

12. A system for multi-file transfer via instant messaging, comprising:
a system for selecting a plurality of files to be transferred;
a system for generating a collection descriptor describing the files;
a system for sending an instant message with a collection reference that includes the collection descriptor to a recipient; and
a system for allowing the recipient, upon receipt of the instant message, to selectively retrieve at least one of the files.

13. The system of claim 12, wherein the collection descriptor further describes at least one of: a name and location of each file, one or more relationships between the files, one or more properties of each file, and one or more available transformations that can be performed on each file as part of the transfer.

14. The system of claim 12, wherein the collection reference further provides at least one of a file transfer protocol to be used, a physical location of each file, and a name of the collection descriptor.

15. The system of claim 12, further comprising:
a system for specifying at least one relationship defining a collection of the files, wherein information regarding each relationship is included in the collection descriptor.

16. The system of claim 15, further comprising:
a system for displaying information regarding each relationship to the recipient.

17. The system of claim 16, further comprising:
a system for transferring a collection of the files defined by a relationship to the recipient; and
a system for organizing the transferred collection of files on a computer of the recipient in accordance with the relationship.

18. The system of claim 12, further comprising:
a system for displaying a list of the files to the recipient.

19. The system of claim 18, further comprising:
a system for selecting, by the recipient, at least one of the files from the list; and
a system for transferring each selected file to the recipient.

20. The system of claim 19, further comprising:
a system for selecting, by the recipient after the file transfer, at least one additional file from the list; and
a system for transferring each additional selected file to the recipient.

21. The system of claim 12, further comprising:
a system for setting a transfer completion criterion; and
a system for preventing transfer of the files to the recipient after the transfer completion criterion has been met.

22. The system of claim 12, further comprising:
a system for selecting, by the recipient, a file from the list;
a system for selecting, by the recipient, a transformation to be performed on the selected file;
a system for performing the transformation on the selected file to provide a transformed file; and
a system for transferring the transformed file to the recipient.

23. A program product stored on a computer readable medium for multi-file transfer via instant messaging, the computer readable medium comprising program code for performing the steps of:
selecting a plurality of files to be transferred;
generating a collection descriptor describing the files;
sending an instant message with a collection reference that includes the collection descriptor to a recipient; and
upon receipt of the instant message by the recipient, selectively retrieving at least one of the files.
